(19) United States
(12) Patent Application Publication
(10) Pub. No.: US 2008/0133534 A1
(43) Pub. Date: Jun. 5, 2008

(54) Method for providing parts supportive information

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/497,050

(22) Filed: Aug. 1, 2006

Related U.S. Application Data
(60) Provisional application No. 60/704,815, filed on Aug. 1, 2005.
(60) Provisional application No. 60/764,931, filed on Feb. 3, 2006.
(60) Provisional application No. 60/780,473, filed on Mar. 8, 2006.

(51) Int. Cl. G06F 17/30

(52) U.S. Cl. 707/10; 707/E17.107

(57) ABSTRACT

A method for providing technical support regarding parts to a client implementing movies for demonstrating the part's installation procedure.

### RELATED APPLICATIONS

This application claims the benefit of: provisional patent application Ser. No. 60/704,815, filed 2005 Aug. 1, provisional patent application Ser. No. 60/764,931 filed 2006 Feb. 3, and provisional patent application 60/780,473 filed 2006 Mar. 8, by the present inventor

### BACKGROUND

1. Field of the Present Disclosure

This disclosure relates to several methods for providing information. More specifically, a method for providing technical support information to clients regarding the installation of parts.

2. Description of Related Art

Because of the latest technological breakthroughs, more sophisticated and complex machines are now populating the markets. Simple service and maintenance procedures now require of complex equipment diagnosis, service modes, programming and others. As a result, the basic and typical mechanical instinct does not suffice anymore, when it comes to repair some of the latest machines. In addition, offices and homes depend on a myriad of apparatuses pushing the abilities of its occupants whom are now forced to perform within tighter schedules, higher demands and superior expectations. Small budgets such as that of the home-office make issues like time and money of an absolute essence. On the other hand, the explosion of the Internet has open the doors of many websites and enterprises involved in e-commerce looking to sell or auction all kinds of machines, parts and services. The tremendous capabilities of the Internet have facilitated the access to equipment and equipment information unlike ever seen before. Swiftly, purchases and auctions from the Internet require from the ever demanding knowledge and abilities of the client to perform the many given installations. But as of this wasn't enough, self-servicing and maintenance is a more likely possibility. In consequence, Internet sales of parts and supplies have escalated into large industries and enterprises. The owners of machines can now buy literally any part needed with little effort required. Clients for example, can buy from toner for the copiers to roller-kits to evade the always feared paper jams. However, while most equipment includes manuals and documents to perform the proper installation of the machine, the installation of parts on the other hand has extremely little or absolutely no document support. It will indeed be too expensive to print a document for every shipped part. Also, the quality of the manuals (if any) is many times questionable, images in black and white, or engineering drawings are not the choice of the general public. In addition, manuals and printed material are very difficult and tedious to follow, especially when time is trailing, and frustration or anxiety could potentially become a part of the replacement endeavor.

Another upshot as a consequence of the revolution of machine technicality is that what technical field personnel experiences every day. The market has become inhabited with tens if not hundreds of models. New models are ever coming and time for training and reading manuals is now a luxury affordable by few. This is especially true when the technician is faced with replacing and installing small parts. Parts replacement require many times of proper experience, an experience that lately not even the most advanced training departments can afford to teach. For example, in the laser printer industry, there are so many models that is literally impossible to keep track of all changes, in particular the small ones. Field service technicians are constantly challenged in their skills and memories, as if it wasn't enough to deal with the traffic and all the other pearls of their complicated lives.

Warranty departments are another sample of an industry affected by the installation of parts. When a problem or malfunction occurs because of a defective part, the manufactures need to accommodate a series of infrastructures and financial expenses in order to return the equipment to full operation. In addition, the client is delayed procuring a series of other inconveniences. Although more modular machines are now common, to expect a client to read a document mentioning different parts and names he/she has never heard before in order to replace the malfunctioning part can easily proof to be a mistake.

Many websites such as www.partsnow.com, www.pressionroller.com, and www.hp.com, have demonstrated to be very successful enterprises by selling the many parts to keep their client's equipment running properly. However, such websites fail to provide parts support in an effective and self-training manner. Telephone calls and Internet chatting serve of little purpose when it comes to explain a non-familiar client how to replace a recently purchased part per se.

In view of the foregoing and shortcomings, the disclosed inventive method solves long felt needs and provides unappreciated advantages distinguishing it over the prior art by also providing heretofore additional unknown advantages as described in the following summary and detail description.

### SUMMARY

It is therefore an object of the present invention to teach a method for providing parts support to clients in a quick, objective, affordable and up-to-date manner. This disclosure teaches certain benefits in construction and use which give rise to the objectives described below.

A primary objective inherent in the above described method of use is to provide advantages not taught by the prior art;

Another objective is to save time and money to clients;

Another objective is to avoid client from procuring their own data extrapolation and therefore enabling mistakes;

Another objective is to avoid client frustration and anxiety;

Another objective is to assist field technical personnel;

Another objective is to free technical support departments from the responsibility of delivering parts installation information;

Another objective is to save time to the client by eliminating website searches;

Another objective is to standardize the quality of part's installing information;

Another objective is to standardize the quantity of part's installing information;

Another objective is to enhance the capabilities of the Internet for delivering quality and life changing information;

Another objective is to alleviate warranty related repairs and/or expenses;

Another objective is to promote business opportunities for e-commerce of parts;

Another objective is to help client identify the complexity of parts replacing procedures before item is purchased;

Another objective is to avoid dangerous and unsafe situations when replacing a part, since a movie can provide more detail and warning information than any document could;

A further objective is to permit information delivery into many language platforms

A further objective is to deliver information to dyslexic people;

A further objective is to reduce the unnecessary printing and production of parts installation manuals;

A further objective is to reduce the cost of producing unnecessary installation parts manuals;

Other features and advantages of the described methods of use will become apparent from the following more detailed description, taken in conjunction with the accompanying drawings, which illustrate, by way of example, the principles of the presently described method of its use.

### BRIEF DESCRIPTION OF THE DRAWINGS

The accompanying drawings illustrate at least one of the best mode embodiments of the present method of it use. In such drawings:

FIG. 1 is a perspective view the inventive method;

FIG. 2 is

FIG. 3 is a

FIG. 4 is a

### DETAILED DESCRIPTION

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

This disclosure describes a method for providing parts support to the clients. Exemplary of an image forming apparatus such as a printer, copier, scanner, and facsimile machine; and specifically, in the present instance, deals with any one of the many such equipments that are in use or in the commercial marketplace, at any one time.

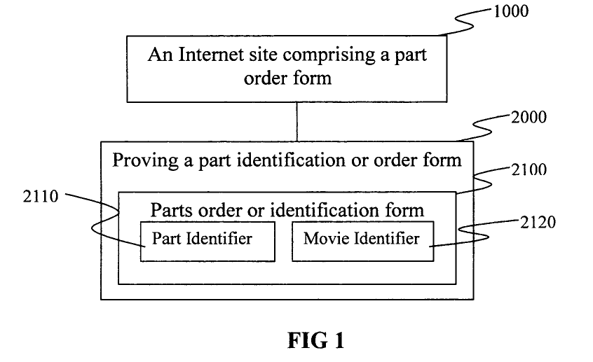

FIG. 1 illustrates a general flow chart of the steps of the embodiment of the inventive method. The first and obvious step is to provide and Internet site 1000 (Fig) involved in e-commerce and/or technical support.

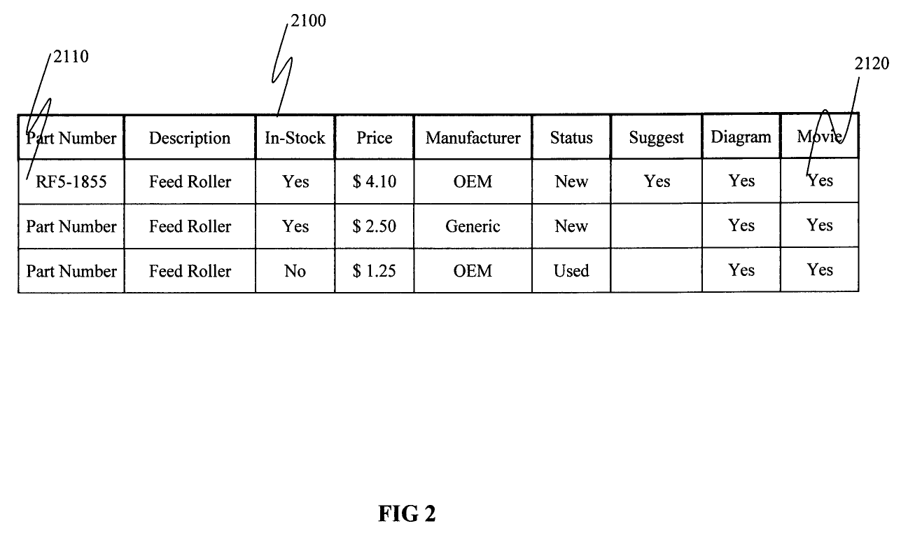

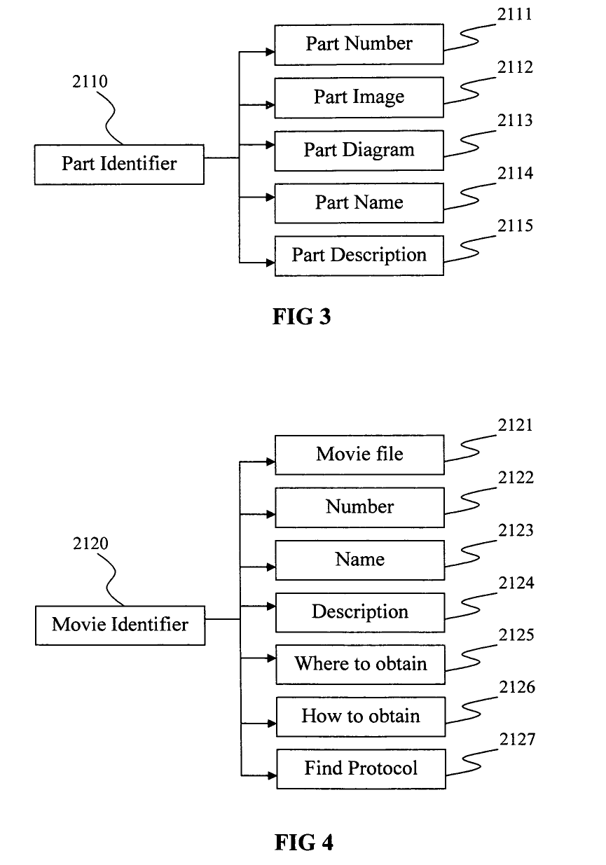

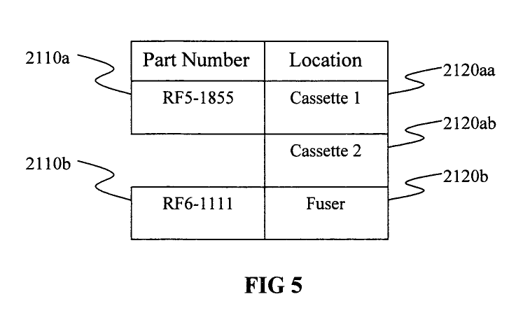

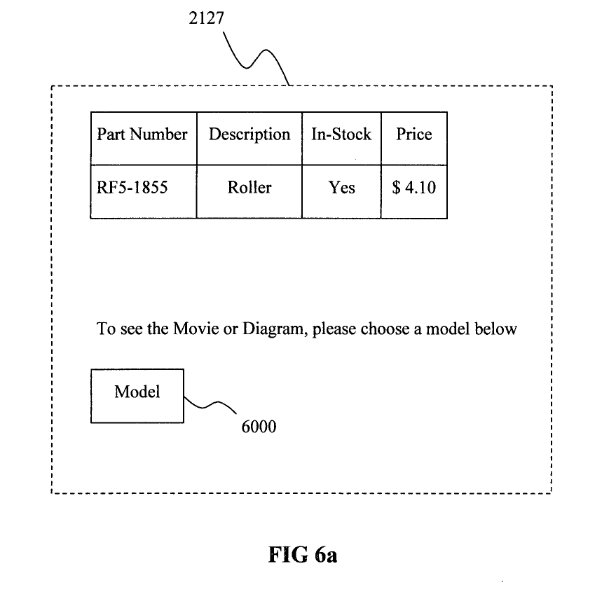

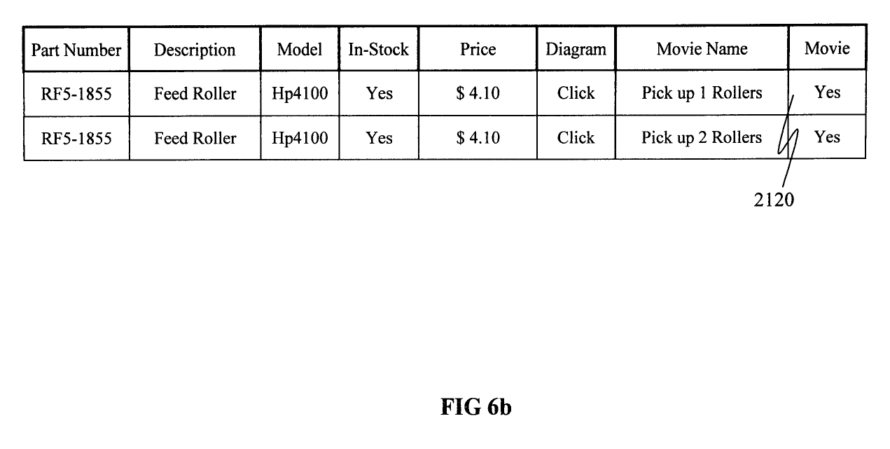

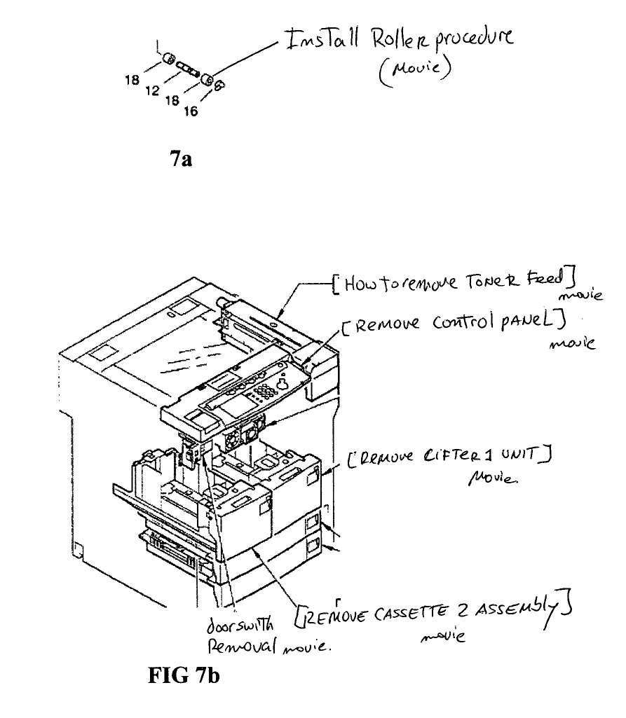

The next step comprises that the internet site 1000 (FIG. 1) provides a display 2000 (FIG. 1) containing a part order or part identification form 2100 (FIG. 1). The part order 2100 (FIG. 1) form contains at least one part identifier 2110 (FIG. 1) and at least one movie identifier 2120 (FIG. 1). FIG. 2 demonstrates a non-limiting yet important sample of an order form 2100 (FIG. 2), a part identifier 2110 (FIG. 2) and a movie identifier 2120 (FIG. 2) among with other possible suggested information, such price, suggested, manufacturer, etc. Noteworthy, the part identifier 2110 (FIG. 2) can have many objectives and/or possible identifying purposes. For example, FIG. 3 illustrates a non-limiting example in form of a table of a part identifier 2110 (FIG. 3) with some of its possible purposes or objectives such as: a part number 2111 (FIG. 3), an image of the part 2112 (FIG. 3), a diagram containing the part 2113 (FIG. 3), the name of the part 2114 (FIG. 3), a detailed description of the part 2115 (FIG. 3). Noteworthy, going back to FIG. 2 and taking a closer look at the parts order form 2100 (FIG. 2), it can be appreciated, that such a type of form helps in the acquirement of a respective movie even when an Internet site is not present. For example, in the case of a handheld device with sufficient memory, a field service technician can quickly get a movie demonstrating the installation. In another sample, the just mention device, this time is used to download the movie wirelessly from a particular server. Referring now to the movie identifier, it can be appreciated that such a movie identifier 2120 (FIG. 2) can also be utilized to identifies many purposes relating to the movie itself. For example FIG. 4, illustrates a non-limiting example of some exemplary purposes of a movie identifier 2120 (FIG. 4) such as at least one of a: the movie 2121 (FIG. 4), movie number 2122, (FIG. 4), movie name 2123 (FIG. 4), movie detail description 2124 (FIG. 4), description where to get the movie 2125 (FIG. 4), description how to obtain the movie 2126 (FIG. 4), a movie finding protocol 2127 (FIG. 4).

Taking a special interest in the “finding protocol” 2127 of FIG. 4, is shown there for a particular and important reason. In the event that a part has only a single place where to be replaced or installed, then simply providing the part identifier and the movie identifier will be sufficient to ultimately provide the movie. In order words, the part is so unique or rare, that it can only be found in one or few locations or machines. FIG. 5 illustrates a sample of such an event, wherein the part identifier 2110a (FIG. 5) is displayed along with the movie identifiers 2120aa (FIG. 5) and 2120ab (FIG. 5). In the particular instant, the client can select the movie the fits his/her need and then view the installation of the part in the machine of choice. Also in FIG. 5, the part identifier 2110b (FIG. 5) is displayed along a single movie identifier 2120b (FIG. 5) indicating a single location for installation of the part that for this particular example, the client can download the movie instead of being able to see it, per se. However, when the particular part has this time many possible destinations for it to be replaced, then a movie finding protocol is necessary to allocate the correct movie demonstrating the respective installation procedure. FIG. 6 shows a non-limiting sample of a movie finding protocol asking the client to select a particular model 6000 (FIG. 6). After selecting the model (in the case of the sample the client selects the hp4100), the protocol proceeds to FIG. 6a to provide a movie identifier 2120 (FIG. 6b), or may continue with further categorizing protocols. FIG. 6b, illustrates the result from selecting the model hp4100. In this instant, when the client selects a movie identifier 2120 (FIG. 6b), the movie will star playing and therefore demonstrating how to replace the pickup roller on unit 1 of the particular model hp4100 laser printer.

Another particular method for providing movies demonstrating installation is that in which a parts diagram has at least one movie identifier of a movie demonstrating the installation of at least one part present in the diagram. FIGS. 7a and 7b are used to illustrate such a method. In FIG. 7a, simply by selecting the identifier 2120-7a (FIG. 7a) the client can see installation of all or most parts in the diagram. By selecting 2120-7a (FIG. 7a) the client can see a movie of how to install the fuser roller per se. FIG. 7b illustrates a more general sample. By selecting 2120-7b1 (FIG. 7b) the client can see how to remove and install the fuser unit, and by selecting 2120-7b2 (FIG. 7b) the client can view how to remove and install the drum/imaging unit of the particular laser printer.

Another method is that in which upon a part acquiring transaction such as at least one of a: purchase, replacement warranty, upgrade, recall and others to name a few, a movie identifier is provided with the part. For example, the client orders the fuser unit of his laser printer; upon receiving of the part, the client can visit an internet site and simply enter the part number or even the particular invoice number to see a movie installing the fuser in another machine identical to that of his model printer.

An additional method is that of part serialization by model. In this method, each part or group of parts is given an identification (such as a part number) associating it directly with the model machine of intent. As a result, a part(s) that is present in many models per se, has different identifications in each model. In such fashion, when a part is ordered, there will be no need to produce any “parts finding protocols”, since the part identification itself ultimately identifies the model too. For example, a part such as a fuser roller per se, is present in the hp4100 and hp5000 models. If one is to see the part number of such fuser roller in the hp4100, one may find that roller's part number is XF-263-4100; and if one refers to the hp5000 data, the same roller has the part number of XF-263-5000 per se. Then, there is the data reference base (database, table, etc) that is used by the manufacturer and/or distributors for associating both serial identifications to implement a single and simple identification.

As demonstrated from the previous figures and detailed exemplary description of the several inventive methods, one can appreciated that there are indeed many possible methods for searching and/or providing a movie, many ways for identifying the elements of the method(s), many categories to identify the movie, many diagrams and pictures; but all in all, without in fact departing from the main spirit of the idea, which is to provide an internet site and/or a parts installing form or protocol wherein a movie identifier is present to ultimately allow the client to view a movie demonstrating the installation of such a part, along of course, with the many data reference bases (database, table, etc) needed to manipulate the data in a efficient and practical manner.

The enablements described in detail above are considered novel over the prior art of record and are considered critical to the operation of at least one aspect of the method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

1. A method for a person for providing technical support to a client, comprising the steps of:
1. Communicating with the client, including at least one of a: end-user, technician, third party person, apparatus, field service apparatus, third party apparatus, and system;
2. Selecting a motion picture demonstrating a servicing procedure;
3. Identifying an Internet Site;
4. Implementing the Internet Site for providing the client an information identifying the selected motion picture;
Whereby client can perform at least one obtaining action including: obtaining information on said motion picture, obtaining information in said motion picture, viewing said motion picture, identifying said motion picture, and downloading said motion picture.
